(19) United States
(12) Patent Application Publication
(10) Pub. No.: US 2015/0001040 A1
(43) Pub. Date: Jan. 1, 2015

(54) Double Flat Detection and Correction System and Method

(71) Applicants: Gabe Difurio, Stevenson, MD (US); Jacob L. Timm, Los Angeles, CA (US)

(72) Inventors: Gabe Difurio, Stevenson, MD (US); Jacob L. Timm, Los Angeles, CA (US)

(73) Assignee: ACCELERATE INC., Stevenson, MD (US)

(21) Appl. No.: 13/933,038

(22) Filed: Jul. 1, 2013

(51) Int. Cl. B65G 47/24

(52) U.S. Cl. CPC B65G 47/24
USPC 198/341.01

(57) ABSTRACT

A double flat detection and correction system includes a feeder for detecting a double flat from multiple flats. The system also includes (i) a stacking unit that stacks one or more flats, and (ii) a de-stacking unit that de-stacks a flat from the one or more flats. The de-stacking unit includes (a) a first sensor unit that detects (i) an edge of the first flat, and (ii) an edge of the second flat when the flat is the double flat, (b) a second sensor unit that detects a presence of the first flat, and (c) a first anti-doubler unit that is activated when (i) the first sensor unit detects the edge of the second flat, and (ii) the second sensor unit detects the presence of the first flat. The system further includes a second anti-doubler unit that is activated when the presence of the first flat is detected.

### BACKGROUND

1. Technical Field

The embodiments herein generally relate to a flat detection and correction system, and more particularly to a double flat detection and correction system and method for detecting two or more flats from a set of flats.

2. Description of the Related Art

When mail items, such as postcards, envelopes, greetings, etc. are sorted in automated sorting machines they are transported by a series of belts and pulleys. Before being fed through a sorting machine, the mail items are arranged in a stack on an input assembly of the sorting machine. A de-stacking unit may include belts, rollers and vacuum or suction components that are used to de-stack one or more mail pieces and feed it into the belt system.

A common problem with typical de-stacking mechanisms is they are known to occasionally pull two or more items into the belt system together. This is known as a ‘double feed’, even though often it can be three or more items. Double-feeds can cause a range of problems for mail administrations such as blocking an operation of the sorting machine, and reducing the quality of servicing mail due to mail being sent to the wrong destination, or not delivered at all.

FIG. 1A illustrates a typical double flat detection and correction system 100 of a feeder. The conventional flat detection and correction system 100 includes a stacking unit 102, a de-stacking unit 104, a control unit 106, a pinch wheels assembly 108, and one or more photoeye sensors (e.g. a first photoeye sensor 110A, and a second photoeye sensor 110B). The stacking unit 102 includes one or more flats 112A-N. The de-stacking unit 104 includes a de-stacking plate 114, a perforated belt 116, a vacuum port 118, and one or more vacuum chambers 120A-B. The one or more vacuum chambers 120A-B are positioned opposite to the sides of the vacuum port 118. The stacking unit 102 is coupled to the de-stacking unit 104 for de-stacking at least one flat from the one or more flats 112A-N. The vacuum port 118 pulls/retrieves a first flat 112A from the one or more flats 112A-N and transports to a flat transport path 122. The first flat 112A advances towards the pinch wheels assembly 108 based on a vacuum level in the one or more vacuum chambers 120A-B. The first photoeye sensor 110A is positioned between the pinch wheels of the pinch wheels assembly 108. The second photoeye sensor 110B is positioned after the pinch wheels assembly 108. The de-stacking unit 104 further includes an anti-doubler unit 124 which is turned on when a leading edge of the first flat 112A is detected in the first photoeye sensor 110A.

The vacuum port 118 may pull/retrieve a double flat 112A-B from the one or more flats 112A-N. The double flat 112A-B includes the first flat 112A and a second flat 112B. The leading edges of the first flat 112A and the second flat 112B may align in different degrees. The degree to which the leading edges are aligned is called “shingle”. Zero shingle, positive shingle, and a negative shingle are three different types of shingles.

FIG. 1B illustrates the double flat 112A-B that includes the first flat 112A and the second flat 112B with the zero shingle. The respective leading edges of the first flat 112A and the second flat 112B are aligned perfectly, which indicates a zero shingle is present in the double flat 112A-B as shown in FIG. 1B. FIG. 1C illustrates the double flat 112A-B that includes the first flat 112A and the second flat 112B with the positive shingle. The leading edge of the first flat 112A leads the leading edge of the second flat 112B which indicates that the positive shingle is present in the double flat 112A-B as shown in FIG. 1C. FIG. 1D illustrates the double flat 112A-B that includes the first flat 112A and the second flat 112B with the negative shingle. The leading edge of the first flat 112A trails the leading edge of the second flat 112B which indicates that the negative shingle is present in the double flat 112A-B as shown in FIG. 1D.

The de-stacking unit 104 de-stacks the double flat 112A-B with the positive shingle from the stacking unit 102. The anti-doubler unit 124 is turned on when a leading edge of the first flat 112A is detected in the first photoeye sensor 110A. As the first flat reaches a pinch point of the pinch wheel assembly 108, the anti-doubler unit 124 holds the second flat 112B and allows the first flat 122A to pass the pinch wheels assembly 108. The typical double flat detection and correction system 100 detects the double flat 112A-B only when the first flat of the double flat 112A-B reaches a pinch point of the pinch wheel assembly 108. Accordingly, there remains a need for an improved double flat detection and correction system to effectively detect the double flats before the double flats leave the feeder assembly.

### SUMMARY

In view of the foregoing, an embodiment herein provides a double flat detection and correction system having a feeder for detecting a double flat from a plurality of flats, wherein the double flat comprises a first flat and a second flat, the double flat detection and correction system comprising a stacking unit that stores the plurality of flats; and a de-stacking unit that de-stacks a flat from the plurality of flats, wherein the de-stacking unit comprises a first sensor unit that detects an edge of the first flat, and an edge of the second flat when the flat is the double flat; a second sensor unit that detects a presence of the first flat; and a first anti-doubler unit that is activated when the first sensor unit detects the edge of the second flat, and the second sensor unit detects the presence of the first flat. The system may further comprise a pinch wheels assembly positioned downstream to the de-stacking unit; and a first photoeye sensor positioned in between pinch wheels of the pinch wheels assembly, wherein the first photoeye sensor detects a presence of the first flat. The de-stacking unit may comprise a second anti-doubler unit that is activated when the presence of the first flat is detected by the first photoeye sensor. The system may further comprise a control unit that activates (i) the first anti-doubler unit when (a) the first sensor unit detects the edge of the second flat, and (b) the second sensor unit detects the presence of the first flat, and (ii) the second anti-doubler unit when the presence of the first flat is detected by the first photoeye sensor.

The first sensor unit may include an emitter that emits an energy beam toward a flat transport path such that the energy beam is affected by the passing of flats; and a plurality of receivers that receive a reflected energy beam. The first sensor unit may detect the edge of the first flat and the edge of the second flat of the double flat based on the reflected energy beam received in the plurality of receivers. The second sensor unit may comprise a photoeye sensor. The plurality of flats may comprise any of a sheet, a letter, a postcard, a mail, a check, an envelope, a magazine, a catalog, and combinations thereof.

Another embodiment provides a system for detecting and correcting a double flat from a plurality of flats, wherein the double flat comprises a first flat and a second flat, the system comprising a stacking unit that stacks the plurality of flats and a de-stacking unit that de-stacks a flat from the plurality of flats and transports the flat to a flat transport path, wherein the de-stacking unit comprises a first sensor unit that detects an edge of the first flat, and an edge of the second flat when the flat is the double flat; a second sensor unit that detects a presence of the first flat; and a first anti-doubler unit that is activated when the first sensor unit detects the edge of the second flat, and the second sensor unit detects the presence of the first flat. The system further comprises a pinch wheels assembly positioned downstream to the de-stacking unit; a first photoeye sensor positioned in between pinch wheels of the pinch wheels assembly, wherein the first photoeye sensor detects a presence of the first flat; and a second anti-doubler unit that is activated when the presence of the first flat is detected in the first photoeye sensor.

The system may further comprise a control unit that activates (i) the first anti-doubler unit when (a) the first sensor unit detects the edge of the second flat, and (b) the second sensor unit detects the presence of the first flat, and (ii) the second anti-doubler unit when the presence of the first flat is detected in the first photoeye sensor. The system may further comprise a second photoeye sensor positioned next to the pinch wheels assembly, wherein the second photoeye sensor detects a presence of the first flat. The first sensor unit may include an emitter that emits an energy beam toward a flat transport path such that the energy beam is affected by the passing of flats; and a plurality of receivers that receive a reflected energy beam. The first sensor unit may detect the edge of the first flat and the edge of the second flat of the double flat based on the reflected energy beam received in the plurality of receivers. The energy beam may comprise any of a light beam and an infrared beam. The second sensor unit may comprise a photoeye sensor. The plurality of flats may comprise any of a sheet, a letter, a postcard, a mail, a check, an envelope, a magazine, a catalog, and a combination thereof.

Another embodiment provides a method for detecting a double flat from a plurality of flats using a double flat detection and correction system, wherein the double flat comprises a first flat and a second flat, the method comprising providing a de-stacking unit comprising a first photoeye sensor, a first anti-doubler unit, and a second anti-doubler unit; de-stacking, using the de-stacking unit, a flat from the plurality of flats; detecting an edge of the first flat and an edge of the second flat when the flat is the double flat; detecting a presence of the first flat; activating the first anti-doubler unit to hold the second flat, when the edge of the second flat is detected, and when a presence of the first flat is detected; detecting, using the first photoeye sensor, a presence of the first flat; and activating the second anti-doubler unit to hold the second flat when the first photoeye sensor detects the presence of the first flat. The method may further comprise providing the double flat detection and correction system with a second photoeye sensor. The method may further comprise detecting, using the second photoeye sensor, a presence of the first flat; and deactivating any of the first anti-doubler unit and the second anti-doubler unit when the second photoeye sensor detects the presence of the first flat. The plurality of flats may comprise any of a sheet, a letter, a postcard, a mail, a check, an envelope, a magazine, a catalog, and a combination thereof.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A illustrates a typical double flat detection and correction system of a feeder;

FIG. 1B illustrates a double flat that includes a first flat and a second flat with a zero shingle;

FIG. 1C illustrates a double flat that includes a first flat and a second flat with a positive shingle;

FIG. 1D illustrates a double flat that includes a first flat and a second flat with a negative shingle;

FIG. 2A illustrates a schematic diagram of a double flat detection and correction system according to an embodiment herein;

FIG. 2B illustrates a side view of the double flat detection and correction system of FIG. 2A according to an embodiment herein;

FIG. 2C illustrates a top view of the double flat detection and correction system of FIGS. 2A and 2B according to an embodiment herein;

FIGS. 3A and 3B illustrate the edge detector unit of FIG. 2B according to an embodiment herein;

FIG. 4A illustrates a perspective view of the first anti-doubler unit of FIG. 2A according to an embodiment herein;

FIG. 4B illustrates a side view of the first anti-doubler unit of FIG. 2A according to an embodiment herein;

FIG. 5A illustrates a perspective view of the pick zone of FIG. 2A according to an embodiment herein;

FIG. 5B illustrates a side view of the pick zone of FIG. 2A according to an embodiment herein;

FIGS. 6A through 6D illustrate the operation of the double flat detection and correction system of FIG. 2B when a first flat is received in a detection space according to an embodiment herein;

FIGS. 7A through 7D illustrate the operation of the double flat detection and correction system of FIG. 2B when the double flat with the positive shingle is received in the detection space according to an embodiment herein; and

FIG. 8 is a flow diagram illustrating a method for detecting a double flat from two or more flats using the double flat detection and correction system of FIG. 2A according to an embodiment herein.

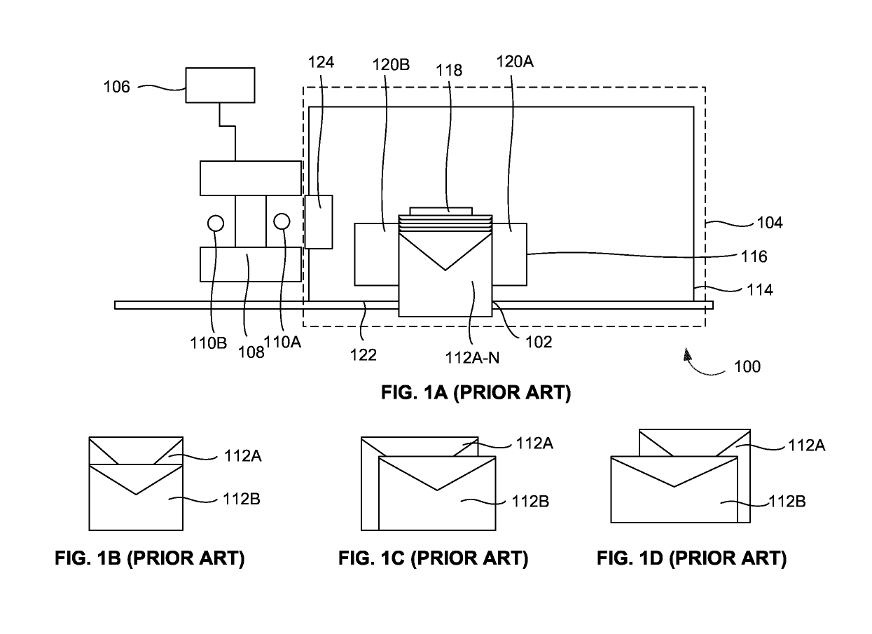

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

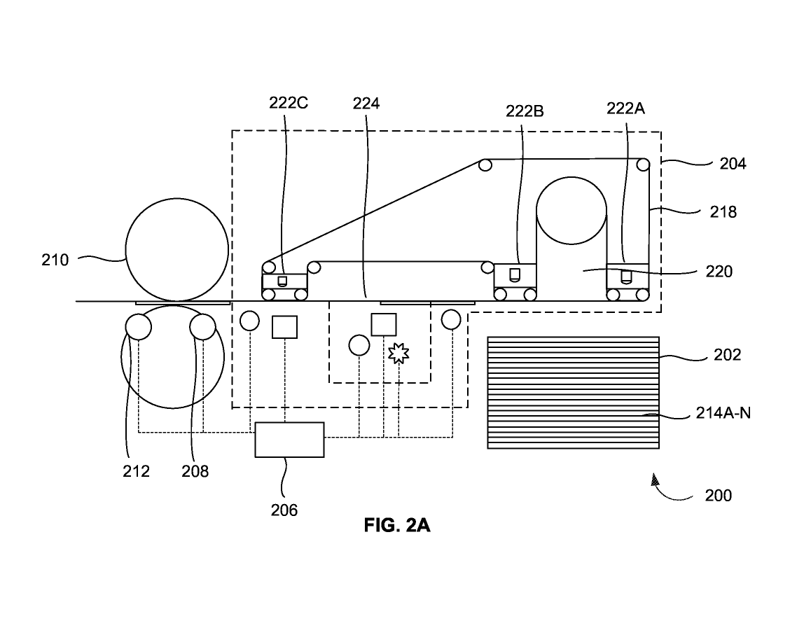

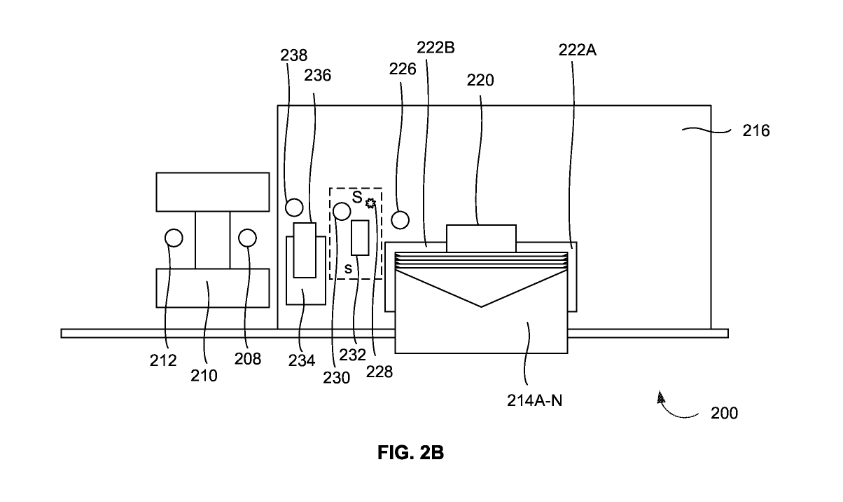

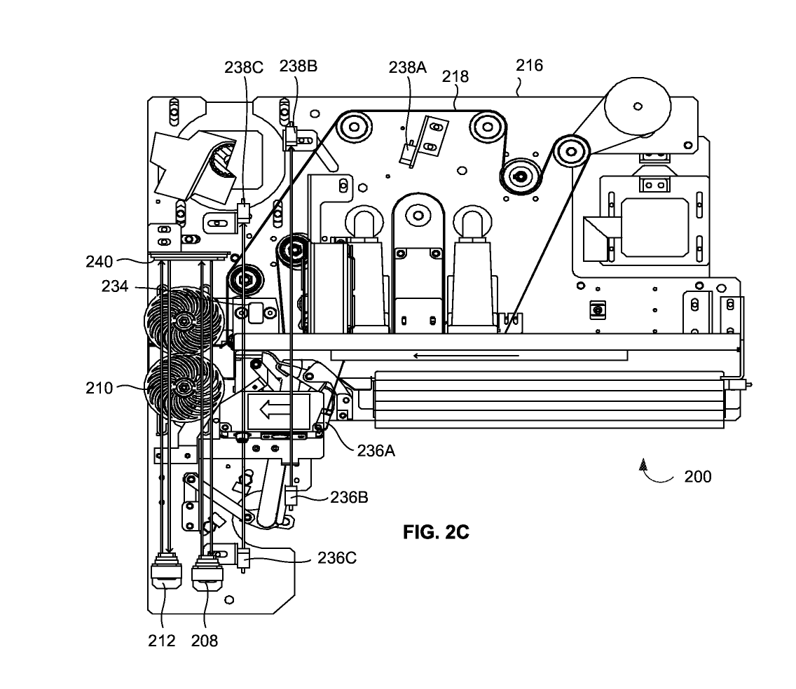

As mentioned, there remains a need for an improved double flat detection and correction system to effectively detect a double flat. The embodiments herein achieve this by providing a double flat detection and correction system with one or more anti-doubler units within a de-stacking unit of a feeder. The double flat detection and correction system uses an edge detection mechanism to detect a double flat received in a flat transport path. The edge detection mechanism uses one or more sensors to detect edges of the double flat. The double flat detection and correction system activates the one or more anti-doubler units when one or more sensors detect edges of the double flat. Referring now to the drawings and more particularly to FIGS. 2A through 8, where similar reference characters denote corresponding features consistently throughout the figures, there are shown preferred embodiments.

FIG. 2A illustrates a schematic diagram of a double flat detection and correction system 200 according to an embodiment herein. The double flat detection and correction system 200 includes a stacking unit 202, a de-stacking unit 204, a control unit 206, a first photoeye sensor 208, a pinch wheels assembly 210, and a second photoeye sensor 212. The de-stacking unit 204 includes a de-stacking plate 216 (not shown in FIG. 2A), a perforated belt 218, a vacuum port 220, a first vacuum chamber 222A, a second vacuum chamber 222B, a third vacuum chamber 222C, and a flat transport path 224. The stacking unit 202 stores one or more flats 214A-N. The one or more flats 214A-N may include sheets, letters, postcards, mails, envelopes, magazines, catalogs and/or checks, or combinations thereof, in example embodiments.

The first flat 214A may be configured as a postcard and the second flat 214B may also be a postcard, in another example embodiment. The first flat 214A may be configured as a postcard, and the second flat 214B may be a different flat (e.g., a letter, a sheet, a mail, an envelope, a magazine, a catalog and/or a check, etc.), in yet another example embodiment. The de-stacking unit 204 is directly connected to the stacking unit 202. The de-stacking unit 204 de-stacks a first flat (e.g., a flat 214A) from the one or more flats 214A-N stored in the stacking unit 202. The control unit 206 controls the operation of the de-stacking unit 204. The first photoeye sensor 208 is positioned between one or more pinch wheels of the pinch wheels assembly 210. The second photoeye sensor is positioned next to the pinch wheels assembly 210. The pinch wheels assembly 210 is positioned downstream to the de-stacker unit 204. The pinch wheels assembly 210 transports the de-stacked flats to the next module of the double flat detection and correction system 200. In this embodiment, the next module may be at least one of a flat thickness measuring module, a barcode reader, a culling module, an injector, an optical character recognition (OCR) that reads an address, and a label.

FIG. 2B illustrates a side view of the double flat detection and correction system 200 of FIG. 2A according to an embodiment herein. FIG. 2C, with reference to FIGS. 2A and 2B, illustrates an exploded view of the double flat detection and correction system 200 according to an embodiment herein. The de-stacking unit 204 further includes the de-stacking plate 216, a vacuum port 220, the first vacuum chamber 222A, the second vacuum chamber 222B, the third vacuum chamber 222C, the flat transport path 224, a first presence sensor 226, an edge detector unit 228 (e.g., a first sensor unit), a second presence sensor 230, a first anti-doubler unit 232, a pick zone 234, a second anti-doubler unit 236, and a third presence sensor 238. In one embodiment, the presence sensors 226, 230, 238 comprise photoeye sensors. The de-stacking plate 216 comprises a vertical plate, in one example embodiment. The third vacuum chamber 222C is a part of the pick zone 234, in one example embodiment.

The presence sensors (e.g. the first presence sensor 226, the second presence sensor 230, and the third presence sensor 238) are in an opposed (through beam) arrangement and includes one or more receivers 238A-C that are located within the line-of-sight of one or more emitters 236A-C. In this mode, the first flat 214A is detected when an energy beam is blocked such that the energy beam is not received at the receiver 238A from the emitter 236A. The energy beam may include a laser, light beam, or infrared beam in example embodiments; although other types of energy beams are possible, and the embodiments herein are not restricted to a particular type of beam.

The de-stacking plate 216 provides support to one or more flats 214A-N which is de-stacked from the stacking unit 202. The perforated belt 218 is looped over the vacuum chambers 222A, 222B, and 222C (as shown in FIG. 2A). The vacuum port 220 pulls/retrieves the first flat 214A from the one or more flats 214A-N stored in the stacking unit 202. In one embodiment, the vacuum port 220 may pull/retrieve the double flat 214A-B from the one or more flats 214A-N. The pick zone 234 receives the first flat 214A from the detection space (S). The pick zone 234 includes the third vacuum chamber 222C which is looped at the front using the perforated belt to pull the first flat 214A against the perforated belt.

In one embodiment, the edge detector unit 228, the first anti-doubler unit 232, and the second presence sensor 230 constitute a detection space (S). The first flat 214A advances to the detection space (S) through the flat transport path 224. The first presence sensor 226 is positioned next to the second vacuum chamber 222B. The first presence sensor 226 detects a presence of the first flat 214A. The control unit 206 controls (i) a vacuum level in the first vacuum chamber 222A and the second vacuum chamber 222B when the first presence sensor 226 detects the presence of the first flat 214A, and (ii) advances the first flat 214A from the vacuum port 220 to the detection space (S).

The edge detector unit 228 detects an edge of the first flat 214A which is received in the detection space (S). The second presence sensor 230 is positioned downstream of the edge detector unit 228. The edge detector unit 228 and the second presence sensor 230 are positioned along the flat transport path 224. In one embodiment, the double flat 214A-B is received in the detection space (S). The double flat includes the first flat 214A and a second flat 214B. The edge detector unit 228 detects an edge (e.g. a leading edge) of the first flat 214A. The second presence sensor 230 detects the presence of the first flat 214A.

The edge detector unit 228 further detects an edge (e.g. a leading edge) of the second flat 214B. The first anti-doubler unit 232 is activated by control unit 206 when (a) an edge of the second flat 214B is detected in the edge detector unit 228, and (b) the second presence sensor 230 detects the presence of the first flat 214A. The pinch wheels assembly 210 is configured on only one side of the detection space (S).

The first flat 214A advances to the pinch wheels assembly 210 via the third vacuum chamber 222C. The first photoeye sensor 208 detects the presence of the first flat 214A. The control unit 206 activates the second anti-doubler unit 236 based on the output from the first photoeye sensor 208. In one embodiment, the control unit 206 activates the second anti-doubler unit 236 when the first photoeye sensor 208 detects the presence of the first flat 214A.

The third presence sensor 238 detects the presence of the first flat 214A at the end of the pick zone 234. The third presence sensor 238 advances the first flat 214A from the detection space (S) to the pick zone 234 when it is blocked. For example, the first flat 214A advances to the pick zone 234 from the detection space (S) when the presence of the first flat 214A is not detected by the third presence sensor 238. The control unit 206 controls the vacuum level in the second vacuum chamber 222B such that the first flat 214A advances to the pick zone 234. When the second vacuum chamber 222B is switched OFF, and the third vacuum chamber 222C is switched ON, the first flat 214A advances to the pinch wheel assembly 210.

The second photoeye sensor 212 is positioned next to the pinch wheels assembly 210. The second photoeye sensor 212 detects the presence of the first flat 214A at the end of the pinch wheels assembly 210. The control unit 206 deactivates the first anti-doubler unit 232 when (a) the second anti-doubler 236 is switched ON, (b) the second presence sensor 230 is cleared, (c) the third presence sensor 238 is cleared, or (d) the vacuum in the pick zone 234 is switched ON.

The photoeye sensor (e.g. the first photoeye sensor 208, and the second photoeye sensor 212) is configured in an retro-reflective arrangement and includes a receiver (e.g., receivers 238A-C) and an emitter (e.g., emitters 236A-C) in the same unit. The receiver (e.g., receivers 238A-C) and the emitter (e.g., emitters 236A-C) are aimed at a reflector 240, which is located on the opposite side of the emitter (e.g., emitters 236A-C) and the receiver (e.g., receivers 238A-C). In this mode, the first flat 214A (of FIG. 2B) is detected when the energy beam is blocked such that the energy beam is not received by the receiver (e.g., receivers 238A-C) from the emitter (e.g., emitters 236A-C).

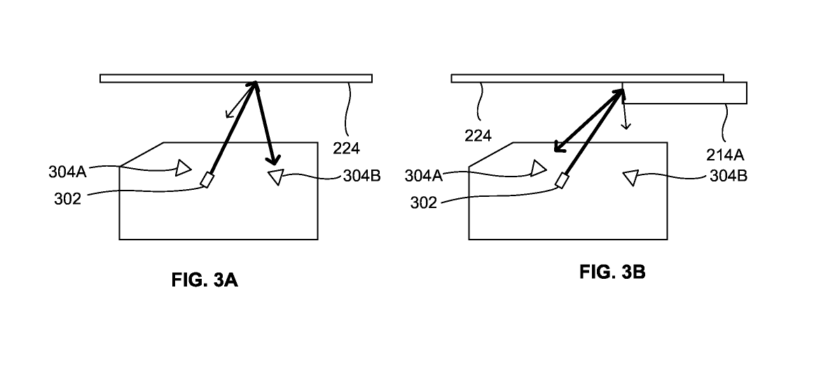

FIGS. 3A and 3B illustrate the edge detector unit 228 of FIG. 2B according to an embodiment herein. The edge detector unit 228 includes an emitter 302 (e.g., laser emitter in one example embodiment), a first receiver 304A, and a second receiver 304B. In one embodiment, the edge detector unit 228 includes more than two receivers. The emitter 302 emits an energy beam (e.g., laser, light, infrared, etc.). The first receiver 304A and the second receiver 304B are positioned adjacent to the emitter 302 as shown in FIG. 3A.

The edge detector unit 228 directs the energy beam towards the flat transport path 224 as shown in FIG. 3A. The first receiver 304A and the second receiver 304B receive a reflected energy beam from the flat transport path 224. The amount of the reflected energy beam received by the second receiver 304B may be higher than the amount of the reflected energy beam received by the first receiver 304A when there is no flat detected in the flat transport path 224.

The edge detector unit 228 directs the energy beam towards the first flat 214A which is received in the flat transport path 224 (shown in FIG. 3B). In this case, the amount of the reflected energy beam received by the second receiver 304B may be lower than the amount of the reflected energy beam received by the first receiver 304A. The shift in receiving the amount of the reflected energy beam indicates that the edge detector unit 228 detects an edge of a flat in the flat transport path 224.

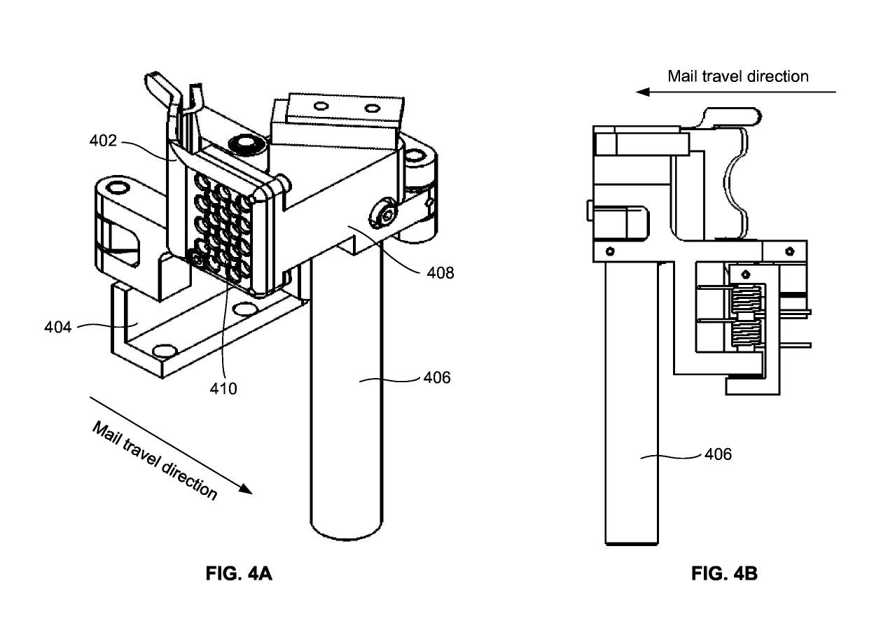

FIG. 4A illustrates a perspective view and FIG. 4B illustrates a side view of the first anti-doubler unit 232 of FIG. 2A according to an embodiment herein. The first anti-doubler unit 232 includes a faceplate 402, a base 404, a tube 406, and a pivoting head 408. The faceplate 402 includes multiple holes 410. The multiple holes 410 communicate via the pivoting head 408 to the tube 406 and allow for a vacuum to be created to hold back a flat. In one embodiment, the faceplate 402 comprises stainless steel. The tube 406 is connected to a vacuum valve (not shown).

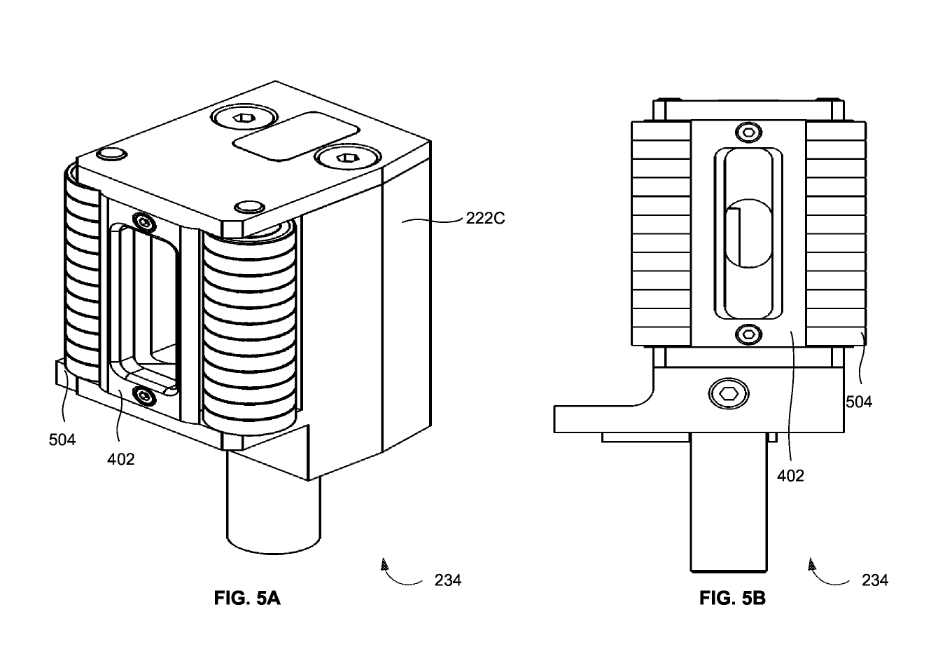

FIG. 5A illustrates a perspective view and FIG. 5B illustrates a side view of the pick zone 234 of FIG. 2B according to an embodiment herein. The pick zone 234 includes the third vacuum chamber 222C, the face plate 402, and a spring assembly 504 (e.g. a conical spring washer). The third vacuum chamber 222C may be a plenum chamber, in one example embodiment. The spring assembly 504 may be a conical spring washer, in another example embodiment.

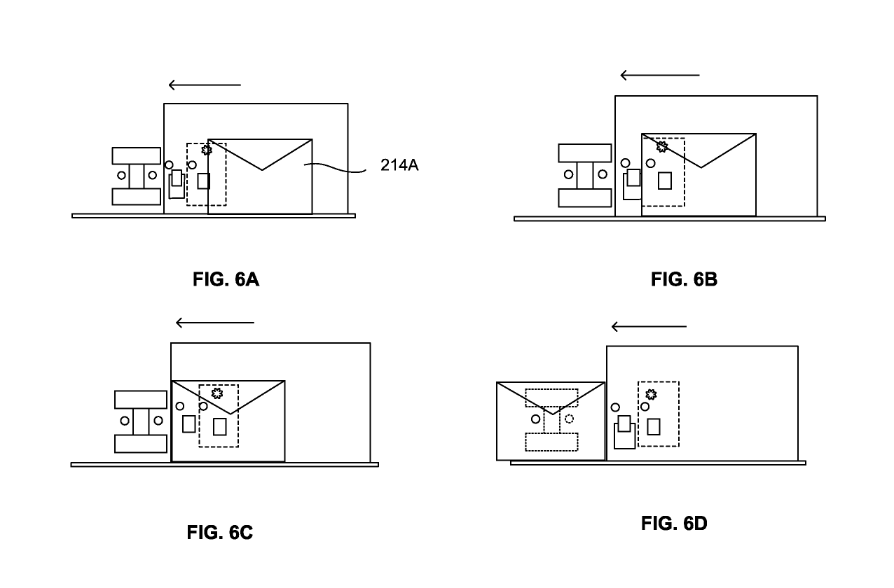

FIGS. 6A through 6D illustrate an operation of the double flat detection and correction system 200 of FIG. 2B when the first flat 214A is received in the detection space (S) according to an embodiment herein. The detection space (S) receives the first flat 214A from the stacking unit 202 as shown in FIG. 6A. The edge detector unit 228 detects an edge of the first flat 214A. The control unit 206 determines that only one flat (e.g., the first flat 214A) is received in the detection space (S) based on the combinational output from the edge detector unit 228 and the second presence sensor 230. Hence, the control unit 206 does not activate the first anti-doubler unit 232 in this embodiment.

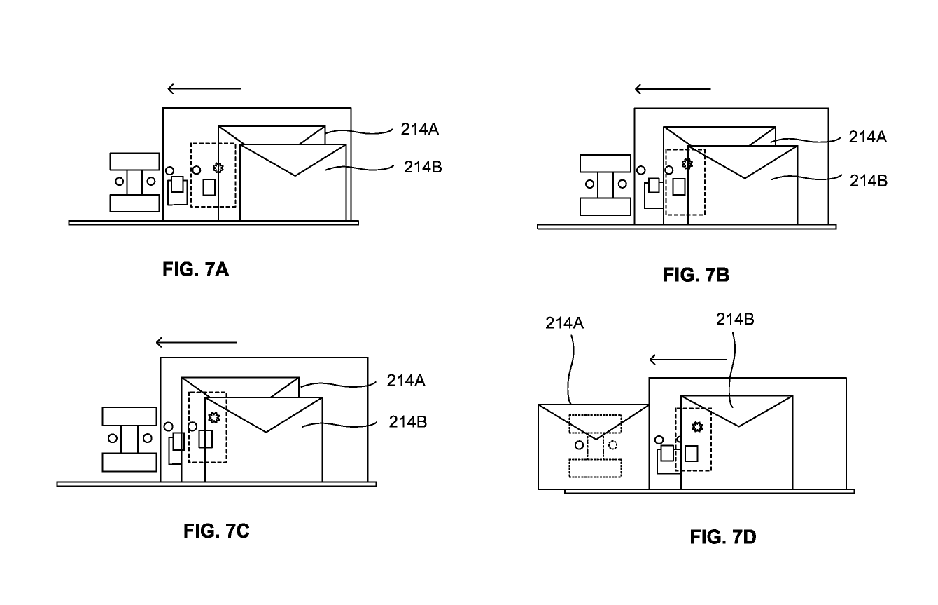

FIGS. 7A through 7D illustrate an operation of the double flat detection and correction system 200 of FIG. 2B when the double flat 214A-B with the positive shingle is received in the detection space (S) according to an embodiment herein. The detection space (S) receives the double flat 214A-B from the stacking unit 202 as shown in FIG. 7A. The double flat 214A-B enters the detection space (S) of the double detection and correction system 200. The double flat 214A-B includes the first flat 214A and the second flat 214B. The edge detector unit 228 detects an edge of the first flat 214A. The first flat 214A advances towards the pick zone 234 through the first anti-doubler unit 232 and the second presence sensor 230 as shown in FIG. 7B. The control unit 206 activates the first anti-doubler unit 232 when (i) the edge detector unit 228 detects an edge of the second flat 214B, and (ii) the second presence sensor 230 detects a presence of the first flat 214A as shown in FIG. 7B.

As shown in FIG. 7C, the first flat 214A advances to the pick zone 234 and the second flat 214B is held by the first anti-doubler unit 232. The control unit 206 (i) activates the second anti-doubler unit 236, and (ii) deactivates the first anti-doubler unit 232 when a presence of the first flat 214A is detected in the first photoeye sensor 208. The first flat 214A advances to the second photoeye sensor 212 through the pinch wheels assembly 210. The control unit 206 deactivates the second anti-doubler unit 236 when (i) the presence of the first flat 214A is not detected in the second presence sensor 230, or (ii) the first flat 214A passes the first photoeye sensor 208 or the third presence sensor 238 as shown in FIG. 7D. In one embodiment, the second anti-doubler unit 236 is deactivated when the double flat detection and correction system 200 picks a next flat.

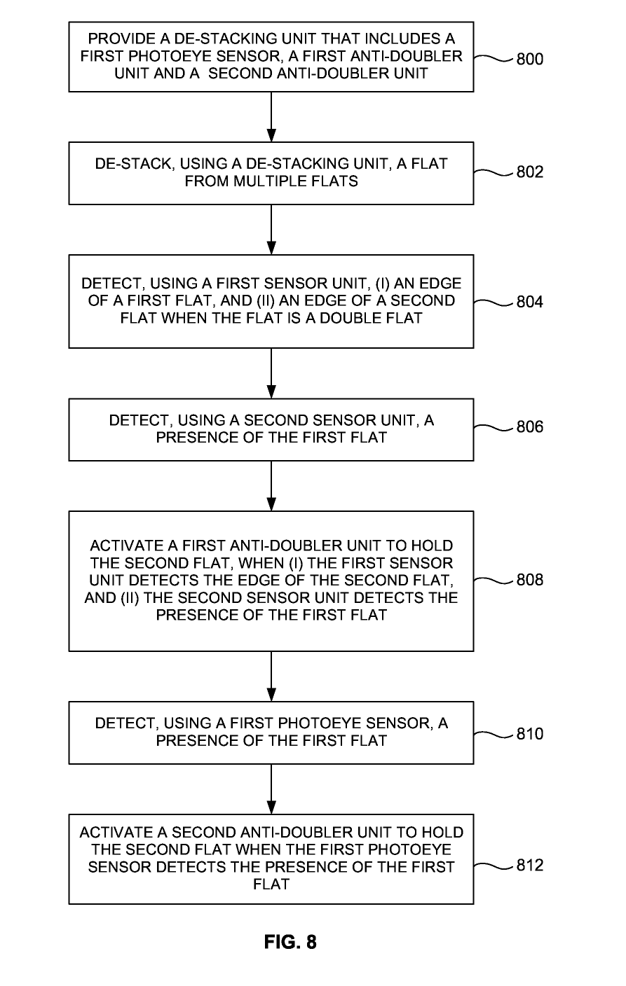

FIG. 8, with reference to FIGS. 2A through 7, is a flow diagram illustrating a method for detecting a double flat from multiple flats using the double flat detection and correction system 200 of FIG. 2A according to an embodiment herein. The double flat includes the first flat 214A and the second flat 214B. In step 800, a de-stacking unit 204 is provided comprising a first photoeye sensor 208, a first anti-doubler unit 232, and a second anti-doubler unit 236. In step 802, a flat is de-stacked from multiple flats using the de-stacking unit 204. In step 804, (i) an edge of the first flat 214A, and (ii) an edge of the second flat 214B are detected, when the flat is a double flat. The edge of the first flat 214A and the edge of the second flat 214B are detected using the first sensor unit (e.g., the edge detector 228 of FIG. 2B).

In step 806, the presence of the first flat 214 is detected using a second sensor unit (e.g., the first presence sensor 226). In step 808, the first anti-doubler unit 232 is activated to hold the second flat 214B, when (i) the first sensor unit 228 detects the edge of the second flat 214B, and (ii) the second sensor unit 226 detects the presence of the first flat 214A. Alternatively, the double flat detection and correction system 200 may include a timer (not shown) instead of a downstream presence sensor (e.g., the second presence sensor 230 and/or the third presence sensor 238), or the photoeye sensor (e.g., the first photoeye sensor 208, and/or the second photoeye sensor 212). The timer may be used between the edge detector pulses of the first flat 214A and the second flat 214B to detect the double flat 214A-B. Further, the timer detects the double flat 214A-B when an edge of the second flat 214B is detected within preset time. In step 810, a presence of the first flat 214A is detected using the first photoeye sensor 208. In step 812, the second anti-doubler unit 236 is activated to hold the second flat 214B when the first photoeye sensor 208 detects the presence of the first flat 214A. The presence of the first flat 214A may be detected using the second photoeye sensor 212. The first anti-doubler unit 232 and the second anti-doubler unit 236 may be deactivated when the second photoeye sensor 212 detects the presence of the first flat 214A.

The double flat detection and correction system 200 detects and corrects the double flat 214A-B received in the detection space (S) based on an edge detection mechanism (e.g., edge detector 228). The edge detector 228 detects the edge of the first flat 214A. The first flat 214A then advances to the pick zone 234 through the second presence sensor 230 and the first anti-doubler unit 232. The control unit 206 activates the first anti-doubler unit 232 when the edge of the second flat 214B is detected in the edge detector 228 while the second presence sensor 230 is blocked by the first flat 214A. The second flat 214B is stopped by the first anti-doubler unit 232 and the first flat 214A advances to the pinch wheels assembly 210. The second anti-doubler unit 236 is activated by the control unit 206 when the presence of the first flat 214A is detected in the first photoeye sensor 208. The control unit 206 deactivates the first anti-doubler unit 232 and the second anti-doubler 236 when the presence of the first flat 214A is detected in the second photoeye sensor 212.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A double flat detection and correction system having a feeder for detecting a double flat from a plurality of flats, wherein said double flat comprises a first flat and a second flat, said double flat detection and correction system comprising:
a stacking unit that stores said plurality of flats; and
a de-stacking unit that de-stacks a flat from said plurality of flats, wherein said de-stacking unit comprises:
a first sensor unit that detects an edge of said first flat, and an edge of said second flat when said flat is said double flat;
a second sensor unit that detects a presence of said first flat; and
a first anti-doubler unit that is activated when said first sensor unit detects said edge of said second flat, and said second sensor unit detects said presence of said first flat.

2. The double flat detection and correction system of claim 1, further comprising:
a pinch wheels assembly positioned downstream to said de-stacking unit; and
a first photoeye sensor positioned in between pinch wheels of said pinch wheels assembly, wherein said first photoeye sensor detects a presence of said first flat.

3. The double flat detection and correction system of claim 2, wherein said de-stacking unit comprises a second anti-doubler unit that is activated when said presence of said first flat is detected by said first photoeye sensor.

4. The double flat detection and correction system of claim 3, further comprising a control unit that activates (i) said first anti-doubler unit when (a) said first sensor unit detects said edge of said second flat, and (b) said second sensor unit detects said presence of said first flat, and (ii) said second anti-doubler unit when said presence of said first flat is detected by said first photoeye sensor.

5. The double flat detection and correction system of claim 1, wherein said first sensor unit comprises:
an emitter that emits an energy beam toward a flat transport path such that said energy beam is affected by the passing of flats; and
a plurality of receivers that receive a reflected energy beam.

6. The double flat detection and correction system of claim 5, wherein said first sensor unit detects said edge of said first flat and said edge of said second flat of said double flat based on said reflected energy beam received in said plurality of receivers.

7. The double flat detection and correction system of claim 1, wherein said second sensor unit comprises a photoeye sensor.

8. The double flat detection and correction system of claim 1, wherein said plurality of flats comprises any of a sheet, a letter, a postcard, a mail, a check, an envelope, a magazine, a catalog, and combinations thereof.

9. A system for detecting and correcting a double flat from a plurality of flats, wherein said double flat comprises a first flat and a second flat, said system comprising:
a stacking unit that stacks said plurality of flats;
a de-stacking unit that de-stacks a flat from said plurality of flats and transports said flat to a flat transport path, wherein said de-stacking unit comprises:
a first sensor unit that detects an edge of said first flat, and an edge of said second flat when said flat is said double flat;
a second sensor unit that detects a presence of said first flat; and
a first anti-doubler unit that is activated when said first sensor unit detects said edge of said second flat, and said second sensor unit detects said presence of said first flat;
a pinch wheels assembly positioned downstream to said de-stacking unit;
a first photoeye sensor positioned in between pinch wheels of said pinch wheels assembly, wherein said first photoeye sensor detects a presence of said first flat; and
a second anti-doubler unit that is activated when said presence of said first flat is detected in said first photoeye sensor.

10. The system of claim 9, further comprising a control unit that activates (i) said first anti-doubler unit when (a) said first sensor unit detects said edge of said second flat, and (b) said second sensor unit detects said presence of said first flat, and (ii) said second anti-doubler unit when said presence of said first flat is detected in said first photoeye sensor.

11. The system of claim 10, further comprising a second photoeye sensor positioned next to said pinch wheels assembly, wherein said second photoeye sensor detects a presence of said first flat.

12. The system of claim 9, wherein said first sensor unit comprises:
an emitter that emits an energy beam toward a flat transport path such that said energy beam is affected by the passing of flats; and
a plurality of receivers that receive a reflected energy beam.

13. The system of claim 12, wherein said first sensor unit detects said edge of said first flat and said edge of said second flat of said double flat based on said reflected energy beam received in said plurality of receivers.

14. The system of claim 12, wherein said energy beam comprises any of a light beam and an infrared beam.

15. The system of claim 9, wherein said second sensor unit comprises a photoeye sensor.

16. The system of claim 9, wherein said plurality of flats comprises any of a sheet, a letter, a postcard, a mail, a check, an envelope, a magazine, a catalog, and a combination thereof.

17. A method for detecting a double flat from a plurality of flats using a double flat detection and correction system, wherein said double flat comprises a first flat and a second flat, said method comprising:
providing a de-stacking unit comprising a first photoeye sensor, a first anti-doubler unit, and a second anti-doubler unit;
de-stacking, using said de-stacking unit, a flat from said plurality of flats;
detecting an edge of said first flat and an edge of said second flat when said flat is said double flat;
detecting a presence of said first flat;
activating said first anti-doubler unit to hold said second flat, when said edge of said second flat is detected, and when a presence of said first flat is detected;
detecting, using said first photoeye sensor, a presence of said first flat; and
activating said second anti-doubler unit to hold said second flat when said first photoeye sensor detects said presence of said first flat.

18. The method of claim 17, further comprising providing said double flat detection and correction system with a second photoeye sensor.

19. The method of claim 17, further comprising:
detecting, using said second photoeye sensor, a presence of said first flat; and
deactivating any of said first anti-doubler unit and said second anti-doubler unit when said second photoeye sensor detects said presence of said first flat.

20. The method of claim 17, wherein said plurality of flats comprises any of a sheet, a letter, a postcard, a mail, a check, an envelope, a magazine, a catalog, and a combination thereof.
